(19) United States
(12) Patent Application Publication
(10) Pub. No.: US 2026/0154696 A1
(43) Pub. Date: Jun. 4, 2026

(54) STANDARDIZATION OF OPEN ACCESS LIT FIBER NETWORKS

(71) Applicant: AT&T Intellectual Property I, L.P., Atlanta, GA (US)

(72) Inventors: Suman Sambareddy, Celina, TX (US); Yuriy Malakov, Fresh Meadows, NY (US); Julie Marzano, Shorewood, IL (US); Dean Garrett, Rockaway, NJ (US); Michael Griffiths, Duluth, GA (US); Scott Baker, Apex, NC (US); Craig Walton, Apex, NC (US)

(73) Assignee: AT&T Intellectual Property I, L.P., Atlanta, GA (US)

(21) Appl. No.: 18/967,817

(22) Filed: Dec. 4, 2024

(51) Int. Cl. G06Q 30/018; G06Q 30/01

(52) U.S. Cl. CPC G06Q 30/018; G06Q 30/01

(57) ABSTRACT

Aspects of the subject disclosure may include, for example, a system that receives requests from an open access provider to validate an address, and provides a product qualification, and handles product orders and service activation for a service provider of a fiber network, using application programming interfaces (APIs) for qualification and customer provisioning applications. Other embodiments are disclosed.

### FIELD OF THE DISCLOSURE

The subject disclosure relates to protocols and interfaces in open access lit fiber networks.

### BACKGROUND

High-speed networks play a role in providing connectivity for various applications and services. The lack of standardization and interoperability often poses challenges in deploying and managing these networks, particularly in the last mile where connectivity to end-user premises is required.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of an open access provider communicating with a service provider in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for standardizing and managing open access lit fiber networks. Other embodiments are described in the subject disclosure.

As used herein, the term “lit fiber network” includes a fiber-optic network where the fiber cables are already equipped with the necessary electronic equipment and are operational, meaning they are “lit” with light signals. This is in contrast to “dark fiber,” which refers to unused fiber-optic cables that are not yet connected to any electronic equipment and are not currently transmitting data.

Various embodiments described herein use one or more application programming interfaces (APIs) to standardize communications between service providers (SPs) and open access providers (OAPs) to automate service provisioning, address validation, product qualification, service activation, and life cycle management of the relationships between customers, SPs and OAPs.

Various embodiments utilize a set of standardized network layers following Telecommunication forum (TMF) guidelines, ensuring compatibility and interoperability across diverse network architectures and technologies, and establish interconnectivity protocols compliant with TMF standards to facilitate seamless communication and data exchange between different segments of the lit fiber network. These protocols enable efficient routing, traffic management, and quality of service (QoS) control.

Additional embodiments, provide a Fiber Broadband API, designed based on TMF standards, that provides a set of RESTful web services for Appointment Dispatch, Address Validation, Qualification, and Product Ordering. These APIs enable automated provisioning, configuration, and management of fiber broadband services, streamlining the customer experience and enhancing operational efficiency.

Additional embodiments includes the automation of service provisioning within open access networks, allowing customers to quickly select and switch between different service providers and services without manual intervention by the network owner. This greatly enhances consumer choice and flexibility, driving competition and innovation among service providers.

Additional embodiments include the capability to seamlessly integrate emerging technologies such as 5G, IoT devices, and future internet protocols into the fiber network infrastructure. This ensures that the network remains relevant and capable of supporting new services and technologies as they emerge, making it a future-proof solution.

Additional embodiments provide for streamlining last mile connectivity. The various embodiments address the complexities and cost challenges associated with deploying fiber to the last mile, particularly in underserved and rural areas. This aspect is useful for expanding high-speed internet access to areas where economic and logistical challenges are most acute.

To these ends, various embodiments utilize standard APIs defined by the TMF to facilitate interoperability and standardization of communications between open access providers and service providers. For example, in some embodiments, TM forum APIs such as TMF 622, TMF 629, TMF 640, TMF 641, TMF 646, TMF 674, and TMF 697 are used to provide standardized communications between open access providers and service providers.

In some embodiments, the TMF 646 API is used for appointment management API. TMF 646 is used to manage appointments for service provisioning and maintenance. It allows service providers to schedule, reschedule, and cancel appointments, ensuring efficient coordination of field service activities. Various embodiments described herein use the TMF 646 API to automate the scheduling of appointments for tasks such as installation, maintenance, and troubleshooting in the open access lit fiber network. This automation enhances operational efficiency and ensures timely service delivery to end-users.

In some embodiments, the TMF 621 API is used to manage trouble tickets. TMF 621 is used to manage trouble tickets, which are records of issues or problems reported by customers or detected by the network. This API allows service providers to create, update, and track trouble tickets, ensuring that issues are resolved efficiently. Various embodiments described herein use the TMF 621 API to automate the process of trouble management within the open access lit fiber network. When a customer or network monitoring system detects an issue, a trouble ticket is automatically created and tracked using this API. This ensures timely resolution of network problems, enhancing service reliability and customer satisfaction.

In some embodiments, the TMF 640 API is used to manage service inventory. TMF 640 is used to manage the inventory of services provided by the network. It allows service providers to keep track of the services available, their configurations, and their statuses. Various embodiments described herein use the TMF 640 API to maintain an up-to-date inventory of all services offered over the open access lit fiber network. This includes tracking the availability and configuration of services, and ensuring that accurate information is available for service provisioning and management. This API also helps in optimizing resource allocation and improving service delivery.

In some embodiments, the TMF 641 API is used for service order management. TMF 641 is used to manage service orders, including the creation, modification, and cancellation of service orders. It standardizes the process of handling customer orders for network services. Various embodiments described herein use the TMF 641 API to streamline the service order management process within the open access lit fiber network. When a customer places an order for a new service or modifies an existing service, this API automates the order processing, ensuring that the service is provisioned accurately and efficiently. This reduces manual intervention and speeds up service delivery.

In some embodiments, the TMF 679 API is used for service qualification. TMF 679 is used to determine the feasibility of providing a specific service to a customer based on their location and the available network resources. It helps service providers assess whether a particular service can be delivered to a customer's premises. Various embodiments described herein use the TMF 679 API to validate customer addresses and qualify them for specific fiber broadband services. This ensures that customers are only offered services that can be reliably delivered to their location, improving customer satisfaction and reducing service delivery issues.

In some embodiments, the TMF 622 is used for product ordering. TMF 622 facilitates the ordering of products and services, including the creation, modification, and cancellation of orders. It standardizes the process of managing customer orders across different service providers. Various embodiments described herein use TMF 622 API to streamline the product ordering process for fiber broadband services. It enables automated order management, allowing customers to easily place, modify, and cancel orders for various services. This automation reduces manual intervention, speeds up order processing, and enhances the overall customer experience.

In some embodiments, the TMF 620 API is used to manage a product catalog. TMF 620 API is used to manage the product catalog, which is a repository of all the products offered by the network. It allows service providers to define, update, and publish product offerings. Various embodiments described herein use the TMF 620 API to maintain a comprehensive product catalog for the open access lit fiber network. This catalog includes detailed information about all available services, their features, and pricing. Service providers can use this API to update the catalog with new services or modify existing ones, ensuring that customers have access to the latest service offerings.

The various embodiments described herein leverage these (and other) TM Forum APIs to create a standardized and automated framework for managing open access lit fiber networks. By implementing these APIs, the various embodiments achieve standardization, automation, enhanced customer experience, and scalability.

The standardization allows all service providers to use the same protocols and processes, promoting interoperability and reducing compatibility issues. The automation of key processes such as appointment scheduling, service qualification, and product ordering, reduce the need for manual intervention and increase operational efficiency. The enhanced customer experience provides a seamless and efficient experience for customers, allowing them to easily access and manage fiber broadband services. And the scalability facilitates the integration of emerging technologies and supports the expansion of the network to new areas, including underserved and rural regions.

One or more aspects of the subject disclosure include a device that includes a processing system with a processor and a memory. The memory stores instructions that, when executed by the processor, perform several operations. The operations may include receiving, at an application programming interface (API) of a qualification application, a request from an open access provider to validate an address, wherein the qualification application supports an service provider of a fiber network; providing, by the API of the qualification application, a product qualification from the service provider of the fiber network to the open access provider; and providing, by an API of a customer provisioning application, a product order and service activation from the service provider of the fiber network to the open access provider.

One or more aspects of the subject disclosure include a non-transitory machine-readable medium, comprising executable instructions that, when executed by a processing system including a processor, facilitate performance of operations. The operations may include receiving, at a first application programming interface (API) for validating customer address and for qualifying the customer addresses for service provisioning, a request from an open access provider to validate an address, wherein the first API supports an service provider of a fiber network; providing, by the first API, a product qualification from the service provider of the fiber network to the open access provider; and providing, by a second API for ordering broadband services, a product order and service activation from the service provider of the fiber network to the open access provider.

One or more aspects of the subject disclosure include a method, comprising: receiving, by a processing system including a processor, at a first telecommunication (TM) forum compatible application programming interface (API) for validating customer address and for qualifying the customer addresses for service provisioning, a request from an open access provider to validate an address, wherein the first TM forum compatible API supports an service provider of a fiber network; providing, by the processing system, a product qualification from the service provider of the fiber network to the open access provider; and providing, by a second TM forum compatible API for ordering broadband services, a product order and service activation from the service provider of the fiber network to the open access provider.

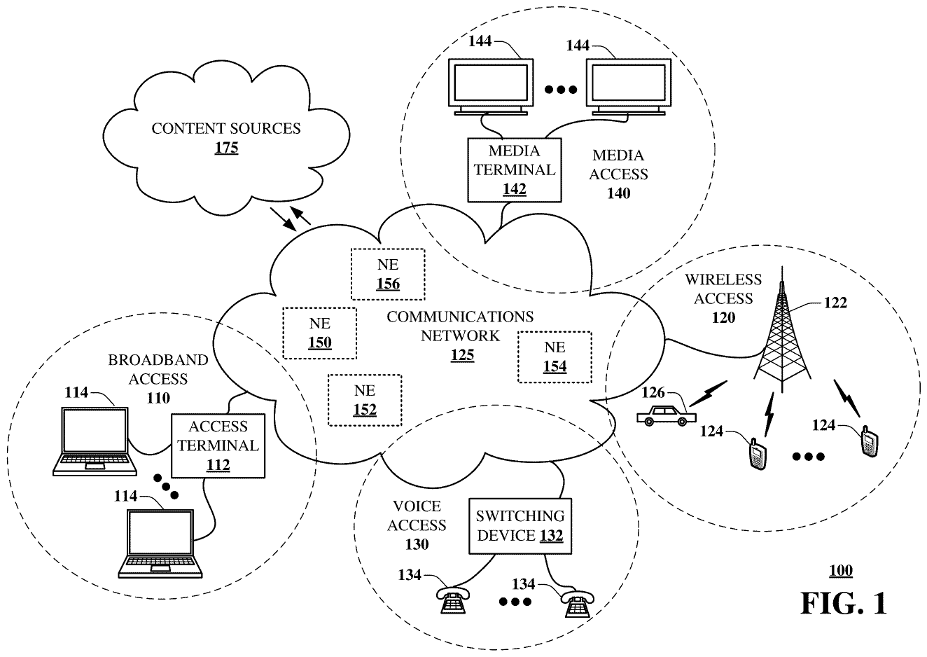

Referring now to FIG. 1, a block diagram is shown illustrating an example, non-limiting embodiment of a system 100 in accordance with various aspects described herein. For example, system 100 can facilitate in whole or in part standardizing and managing open access lit fiber networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

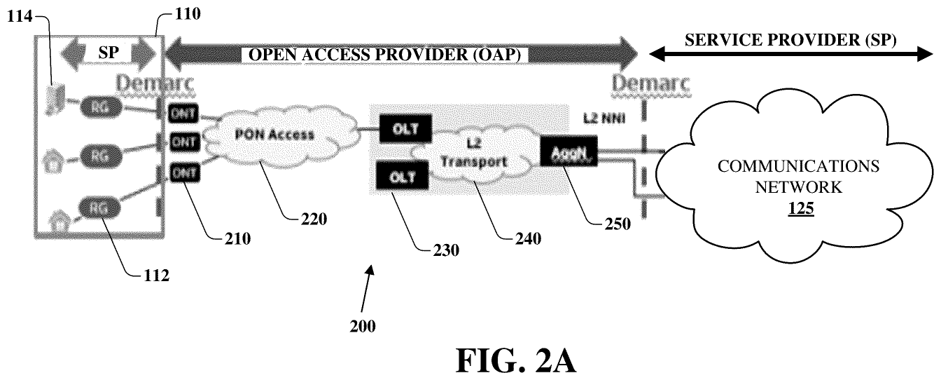

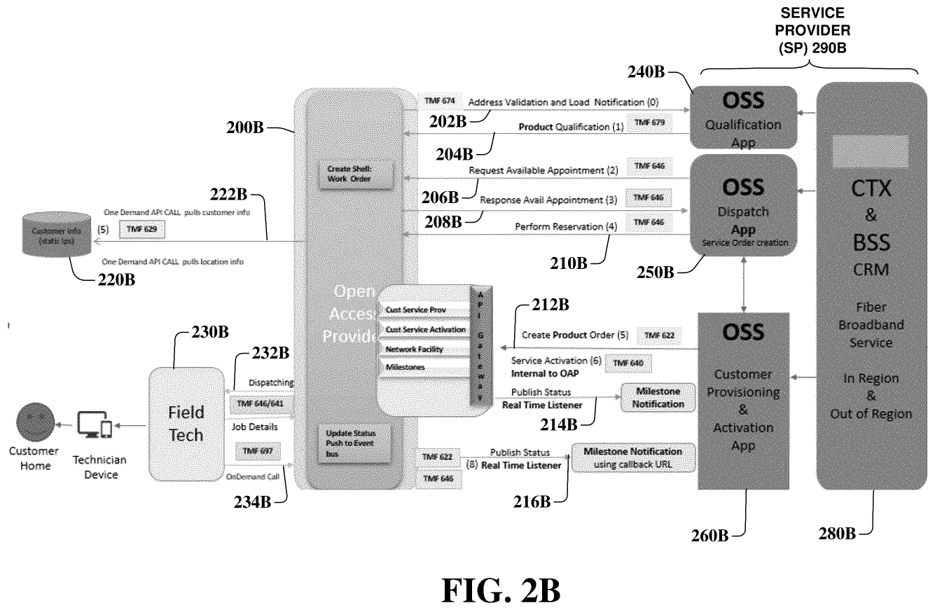

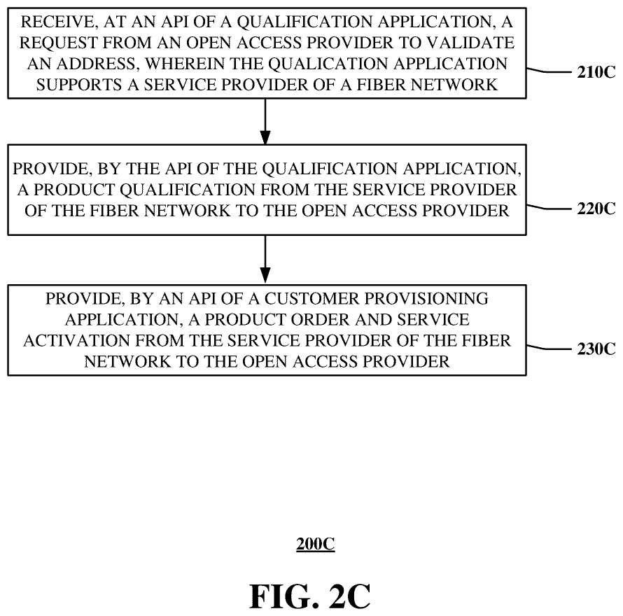

FIG. 2A is a block diagram illustrating an example, non-limiting embodiment of a system functioning within the communication network of FIG. 1 in accordance with various aspects described herein. The system 200 includes Broadband Access 110, Optical Network Terminal (ONT) 210, PON Access 220, Optical Line Terminal (OLT) 230, L2 Transport 240, Aggregation Node (AggN) 250, and Communication Network 125.

Broadband access 110 provides broadband connectivity to various residential gateways (RG) 112 and data terminals 114. ONT 210 is part of the PON (Passive Optical Network) Access 220, which connects the residential gateways to the optical line terminal (OLT) 230. PON Access 220 provides connectivity between the ONT 210 and the OLT 230, facilitating the transmission of data over the fiber network. Optical Line Terminal (OLT) 230 is responsible for managing the data traffic between the PON access 220 and the L2 Transport 240. The L2 Transport 240 transport segment handles the data transmission between the OLT 230 and the aggregation node (AggN) 250. Aggregation Node (AggN) 250 aggregates data from multiple OLTs and connects to the broader communication network 125.

The diagram in FIG. 2A shows the flow of data from the residential gateways (RG) 112 and data terminals 114 through the ONT 210, PON Access 220, OLT 230, L2 Transport 240, and AggN 250, ultimately connecting to the communication network 125. This setup illustrates the standardized and managed open access lit fiber network, ensuring efficient data transmission and connectivity.

As shown in FIG. 2A, the relationship between the Open Access Provider (OAP) and the Service Provider (SP) in the context of an open access lit fiber network is collaborative and symbiotic. Each entity has distinct roles and responsibilities that, when combined, ensure the efficient delivery of high-speed broadband services to end-users. For example, the OAP is responsible for the physical infrastructure of the fiber network including network deployment and maintenance, standardization and interoperability, and resource management.

With respect to network deployment and maintenance, the OAP deploys, manages, and maintains the fiber-optic infrastructure, including the Passive Optical Network (PON) components such as the Optical Network Terminal (ONT), Optical Line Terminal (OLT), L2 Transport, and Aggregation Node (AggN).

With respect to standardization and interoperability, the OAP ensures that the network infrastructure follows standardized protocols and interfaces, such as those defined by the TeleManagement Forum (TMF), to facilitate interoperability with multiple service providers.

With respect to Resource Management, the OAP manages the network resources, including bandwidth allocation, network capacity, and maintenance schedules, to ensure optimal performance and reliability.

The service provider (SP) is responsible for delivering services to end-users over the OAP's infrastructure. For example, this may include service provisioning, customer management, and service activation and management. With respect to service provisioning, the SP may offer various broadband services, such as internet access, VoIP, IPTV, and other value-added services, to end-users, and the SP uses the OAP's infrastructure to deliver these services.

With respect to customer management, the SP handles customer interactions, including service subscriptions, billing, customer support, and service customization. With respect to service activation and management, the SP uses APIs provided by the OAP, such as the TMF 622, TMF 646, and TMF 674 APIs, to automate service provisioning, address validation, product qualification, and service activation.

In some embodiments, the OAP and SP have a collaborative relationship. For example, the relationship between the OAP and the SP is characterized by collaboration and mutual benefit that includes interoperability, API integration, and resource sharing. Through interoperability, the OAP provides a standardized and interoperable network infrastructure that multiple SPs can use to offer their services. This promotes competition and consumer choice. Through API integration, the OAP provides APIs that the SPs use to interact with the network infrastructure. These APIs facilitate automated processes such as service provisioning, address validation, and product ordering, enhancing efficiency and reducing manual intervention. Through resource sharing, the OAP's infrastructure is shared among multiple SPs, reducing the need for each SP to build and maintain their own network. This leads to cost savings and more efficient use of resources. The collaboration between OAPs and SPs ensures high service quality, as the OAP maintains the network infrastructure while the SP focuses on delivering and managing services. This division of responsibilities allows each entity to specialize and excel in their respective areas.

As shown in FIG. 2A, the OAP and SP work together to provide high-speed broadband services to end-users. The OAP manages the physical network infrastructure, ensuring standardization and interoperability, while the SP delivers and manages the services using the OAP's infrastructure. This collaborative relationship enhances service quality, promotes competition, and ensures efficient use of network resources.

FIG. 2B is a block diagram illustrating an example, non-limiting embodiment of an open access provider communicating with a service provider in accordance with various aspects described herein. Service provider 290B includes CTX & BSS CRM 280B, OSS qualification application 240B, OSS dispatch application 250B, and OSS customer provisioning and activation application 260B.

CTX & BSS CRM 280B includes contextual information (CTX) and business support customer relationship management (BSS CRM). CTX refers to contextual information or context-aware systems that provide relevant data and insights to enhance decision-making and service delivery. In the context of service provider 290B, CTX can include various types of information such as customer preferences, service usage patterns, network performance metrics, and environmental factors. This information is used to tailor services, optimize network performance, and improve the overall customer experience.

BSS CRM is a component of service provider's 290B operations, responsible for managing customer interactions, service subscriptions, billing, customer support, and service customization. The BSS CRM system integrates various business processes and customer data to provide a seamless and efficient customer experience. Functions of the BSS CRM include customer data management, service subscription management, billing and invoicing, customer support, service integration, and integration with operation support systems (OSS) such as OSS qualification application 240B, OSS dispatch application 250B, and OSS customer provisioning and activation application 260B.

With respect to customer data management, the BSS CRM maintains accurate and up-to-date records of customer information, including contact details, service subscriptions, billing history, and interaction logs. With respect to service subscription Management, the BSS CRM handles the process of subscribing to new services, modifying existing services, and canceling services. It ensures that customer requests are processed efficiently and accurately. With respect to billing and invoicing, the BSS CRM manages the billing process, generating invoices, processing payments, and handling billing inquiries. It ensures that customers are billed correctly for the services they use. With respect to customer support, the BSS CRM provides tools and systems for managing customer support interactions, including handling inquiries, resolving issues, and tracking support tickets. It ensures that customer issues are addressed promptly and effectively. With respect to service customization, the BSS CRM allows service providers to offer personalized services and packages based on customer preferences and usage patterns. It helps in creating tailored offerings that meet the specific needs of individual customers. With respect to integration with OSS, the BSS CRM integrates with Operations Support Systems (OSS) to ensure seamless coordination between customer-facing activities and network operations. This integration enables efficient service provisioning, activation, and management.

Accordingly, in the various embodiments described herein, the CTX (contextual information) and BSS CRM (Business Support System Customer Relationship Management) 280B are integral components in the context of a service provider such as service provider 290B. CTX provides relevant data and insights to enhance decision-making and service delivery, while BSS CRM manages customer interactions, service subscriptions, billing, and support, ensuring a seamless and efficient customer experience.

OSS qualification application 240B is an application that implements one or more TMF APIs (e.g., TMF 679) to provide communications between an open access provider such as open access provider 200B and a service provider CTX & BSS CRM such as CTX & BSS CRM 280B. OSS qualification refers to the processes and systems used to determine the feasibility of providing a specific service to a customer based on their location and the available network resources. This involves validating customer addresses and assessing whether the requested services can be delivered to the customer's premises.

The functionality provided by OSS qualification application 240B includes address validation, service qualification, and resource availability checks. For example, OSS qualification application 240B may validate addresses to ensure that the customer's address is accurate and can be serviced by the network. Also for example, OSS qualification application 240B may provide service qualification by assessing whether the requested service can be provided based on the network's capabilities and resources. OSS qualification application 240 may also provide resource availability checks by verifying the availability of network resources required to deliver the requested service. As described further below, OSS qualification application 240B may provide these services in response to requests from an open access provider that are made using standardized API calls (e.g., using standardized TMF APIs).

OSS dispatch application 250B is an application that implements one or more TMF APIs (e.g., TMF 646) to provide communications between an open access provider such as open access provider 200B and a service provider CTX & BSS CRM such as CTX & BSS CRM 280B. OSS dispatch refers to the processes and systems used to manage the scheduling and coordination of field service activities, such as installation, maintenance, and troubleshooting. This involves creating service orders, scheduling appointments, and dispatching field technicians to customer locations.

The functionality provided by OSS dispatch application 250B includes service order creation, appointment scheduling, and field technician dispatch. For example, OSS dispatch application 250B may create service orders for tasks such as installation, maintenance, and troubleshooting. Also for example, OSS dispatch application 250B may provide appointment scheduling for field service activities, including requesting available appointment slots, responding to appointment requests, and performing reservations. Also for example, OSS dispatch application 250B may coordinate the dispatch of field technicians to customer locations to perform the required tasks. As described further below, OSS dispatch application 250B may provide these services in response to requests from an open access provider that are made using standardized API calls (e.g., using standardized TMF APIs).

OSS customer provisioning and activation application 260B is an application that implements one or more TMF APIs (e.g., TMF 622, 640, 646) to provide communications between an open access provider such as open access provider 200B and a service provider CTX & BSS CRM such as CTX & BSS CRM 280B. OSS customer provisioning and activation refers to the processes and systems used to provision and activate services for customers. This involves creating product orders, configuring network elements, and activating the requested services.

The functionality provided by OSS customer provisioning and activation application 260B includes product order creation, service activation, and status updates. For example, OSS customer provisioning and activation application 260B may generate product orders for the requested services, configure network elements and activates the requested services for the customer, and provide real-time status updates and milestone notifications to customers and service providers regarding the progress of service provisioning and activation. As described further below, OSS customer provisioning and activation application 260B may provide these services in response to requests from an open access provider that are made using standardized API calls (e.g., using standardized TMF APIs).

Open access provider (OAP) 200B is responsible for ensuring that the network operates efficiently and reliably, providing the necessary support for service providers to deliver high-speed broadband services to end-users.

In some embodiments, OAP 200B provides network infrastructure management. For example, OAP 200B may oversee the deployment, management, and maintenance of the fiber-optic infrastructure, including components such as the Optical Network Terminal (ONT), Optical Line Terminal (OLT), and Aggregation Node (AggN). This ensures that the network is capable of supporting high-speed data transmission and remains operational.

In some embodiments, OAP 200B provides standardization and interoperability. For example, OAP 200B ensures that the network infrastructure follows standardized protocols and interfaces, such as those defined by the TeleManagement Forum (TMF). This standardization facilitates interoperability with multiple service providers, allowing them to offer their services over the same network infrastructure.

In some embodiments, OAP 200B provides resource management. OAP 200B is responsible for managing network resources, including bandwidth allocation, network capacity, and maintenance schedules. This ensures optimal performance and reliability of the network, preventing congestion and ensuring that sufficient resources are available to meet the demands of service providers and end-users.

In some embodiments, OAP 200B provides service coordination. OAP 200B coordinates with service providers such as service provider 290B to facilitate the provisioning and activation of services. This includes managing the scheduling and dispatching of field technicians for tasks such as installation, maintenance, and troubleshooting. The OAP ensures that these activities are carried out efficiently and effectively, minimizing downtime and service disruptions.

In some embodiments, OAP 200B provides real-time monitoring and updates. For example, OAP 200B may provide real-time monitoring of the network's status and performance. It publishes status updates and milestone notifications to keep service providers informed about the progress of service provisioning and activation. This transparency helps service providers manage their operations and customer interactions more effectively.

In some embodiments, OAP 200B provides field technician management. For example, OAP 200B may manage the dispatching and coordination of field technicians that perform on-site tasks such as installation, maintenance, and troubleshooting. This ensures that technical issues are resolved promptly and that services are provisioned and activated efficiently.

The various interactions between the open access provider 200B and the service provider 290B provide for efficient and standardized communication, seamless service provisioning, real-time status updates, and effective resource management. These interactions ensure that the network infrastructure is utilized optimally, services are delivered promptly, and customers receive high-quality broadband services. The use of TMF APIs (e.g., TMF 641, TMF 646, TMF 622, TMF 674, and TMF 640) facilitates automation and interoperability, enhancing the overall performance and reliability of the open access lit fiber network.

In operation, at 222B, the OAP 200B pulls customer information (e.g., a customer's address) from customer information database 220B using the TMF 629. At 202B, the OAP 200B uses the TMF 674 API to communicate with OSS qualification application 240B to validate the customer's address and notify the system of the network load. This ensures that the customer's address is accurate and can be serviced by the network.

At 204B, the OSS qualification application uses the TMF 679 API to communicate with OAP 200B to provide product qualification as a result of determining whether a customer's address qualifies for the requested fiber broadband services. This involves assessing the network's capabilities and resources to ensure service feasibility.

At 206B, the OSS dispatch application 250B uses the TMF 646 API to communicate with OAP 200B to request available appointments, and at 208B, the OAP 200B uses the TMF 646 API to provide responses to appointment requests. At 210B, the OSS dispatch application 250B uses the TMF 646 API to communicate with OAP 200B to reserve appointment slots for service provisioning and maintenance tasks. This ensures that field technicians are scheduled efficiently to meet customer needs. The use of TMF 646 API facilitates the scheduling of field service activities, ensuring efficient coordination between the OAP and SP.

At 212B, the customer provisioning and activation application 260B uses the TMF 622 API to communicate with OAP 200B to create a product order. The use of TMF 622 API standardizes the process of managing customer orders, ensuring accurate and efficient order processing. The OAP 200B uses the TMF 640 API to activate services for customers. This involves configuring network elements and ensuring that the requested services are operational. At 214B and 216B, the OAP 200B uses TMF 622 and/or 646 APIs to publish real-time status updates and milestone notifications. This keeps the SP 290B and customers informed about the progress of service provisioning and activation.

At 232B and 234B, the OAP 200B manages the dispatching of field technicians using the TMF 646/641/697 APIs. This involves coordinating on-site tasks such as installation, maintenance, and troubleshooting to ensure efficient service delivery.

FIG. 2C depicts an illustrative embodiment of a method in accordance with various aspects described herein. At 210C of method 200, a request from an open access provider to validate an address is received at an API of a qualification application, wherein the qualification application supports a service provider of a fiber network, such as a service provider. In some embodiments, the actions of block 210C may be performed to receive a request from an open access provider to validate a customer's address. For example, the system may receive an API call from the open access provider containing the customer's address details and a request for validation. For example, the system may automatically check the address against a database of valid addresses, verify the format and completeness of the address, and ensure that the address is within the serviceable area of the network.

At 220C, a product qualification is provided from the service provider of the fiber network to the open access provider by the API of the qualification application. In some embodiments, the actions of block 220C may be performed to provide a product qualification based on the validated address. For example, the system may assess the network's capabilities and resources to determine if the requested fiber broadband services can be delivered to the customer's address. The system may then generate a product qualification report indicating the available services and their respective configurations. In some embodiments, the system may generate notifications to the open access provider upon successful validation of the address. For example, the system may send an API response or an email notification to the open access provider confirming the successful validation of the address. In some embodiments, the system may store the validated address and product qualification information in a database for future reference and auditing purposes. For example, the system may save detailed logs of the validation results and product qualification reports in a secure database. In some embodiments, the system may verify the availability of network resources before providing the product qualification to the open access provider. For example, the system may check the current network load and resource availability to ensure that the requested services can be delivered without causing congestion or degradation of service quality.

At 230C, a product order and service activation is provided by the service provider of the fiber network to the open access provider by an API of a customer provisioning application. In some embodiments, the actions of block 230C may be performed to provide a product order and service activation from the service provider of the fiber network to the open access provider. For example, the system may create an order record in the database, specifying the customer's details, the validated address, the qualified services, and any additional service options selected by the customer. The system may also configure the necessary network elements to activate the requested services and ensure they are operational. In some embodiments, the system may update the network inventory to reflect the new product order and service activation. For example, the system may update the inventory records to indicate that the requested services have been provisioned and activated for the customer's address. In some embodiments, the system may generate confirmation messages to the open access provider upon successful product order and service activation. For example, the system may send an API response or an email notification to the open access provider confirming the successful creation of the product order and activation of the services. In some embodiments, the system may provide real-time status updates to the open access provider regarding the progress of the product order and service activation. For example, the system may use an API to publish status updates and milestone notifications, such as the completion of address validation, product qualification, order generation, appointment scheduling, technician dispatch, and service activation. In some embodiments, the system may enable the open access provider to modify or cancel the product order through the API of the customer provisioning application. For example, the system may provide an interface or API endpoints that allow the open access provider to make changes to the product order or cancel it if necessary.

In some embodiments, the qualification application and customer provisioning application are integrated with an Operations Support System (OSS) to enhance network management and service delivery. For example, the system may use standardized APIs to communicate with the OSS and ensure seamless coordination between customer-facing activities and network operations. In further embodiments, the system may provide a user interface for the open access provider to interact with the qualification application and customer provisioning application. For example, the system may offer a web-based or mobile interface that allows the open access provider to submit address validation requests, view product qualifications, create product orders, and monitor service activation status. In some embodiments, the system may integrate the qualification application and customer provisioning application with a customer relationship management (CRM) system to enhance customer support and service management. For example, the system may use APIs to synchronize customer data, service orders, and status updates with the CRM system, ensuring a seamless customer experience. In some embodiments, the system may provide analytics and reporting capabilities to monitor the performance and usage of the qualification application and customer provisioning application. For example, the system may generate reports on the number of address validation requests, product qualifications, product orders, service activations, and other key metrics to help the open access provider and service provider optimize their operations.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

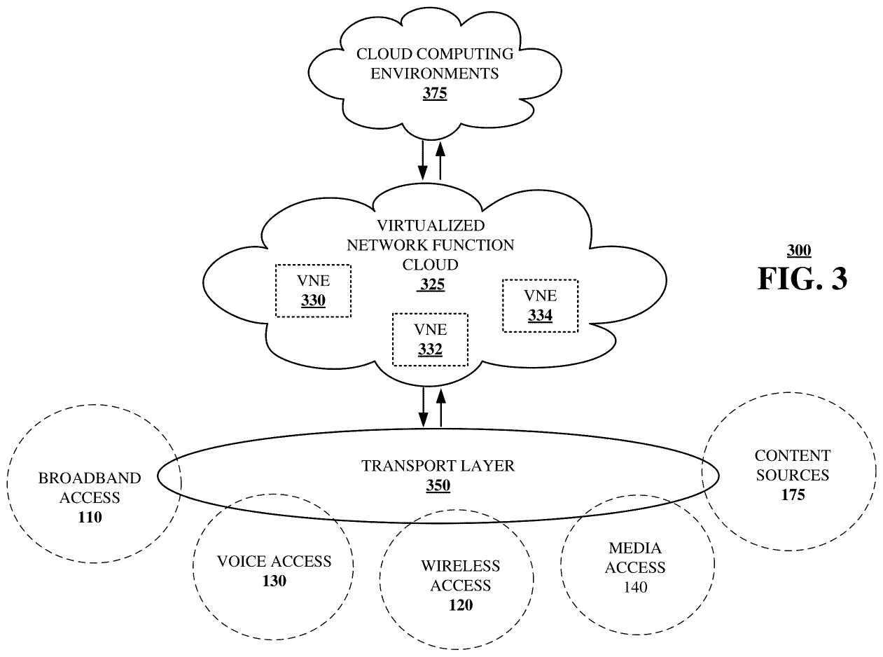

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part standardizing and managing open access lit fiber networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

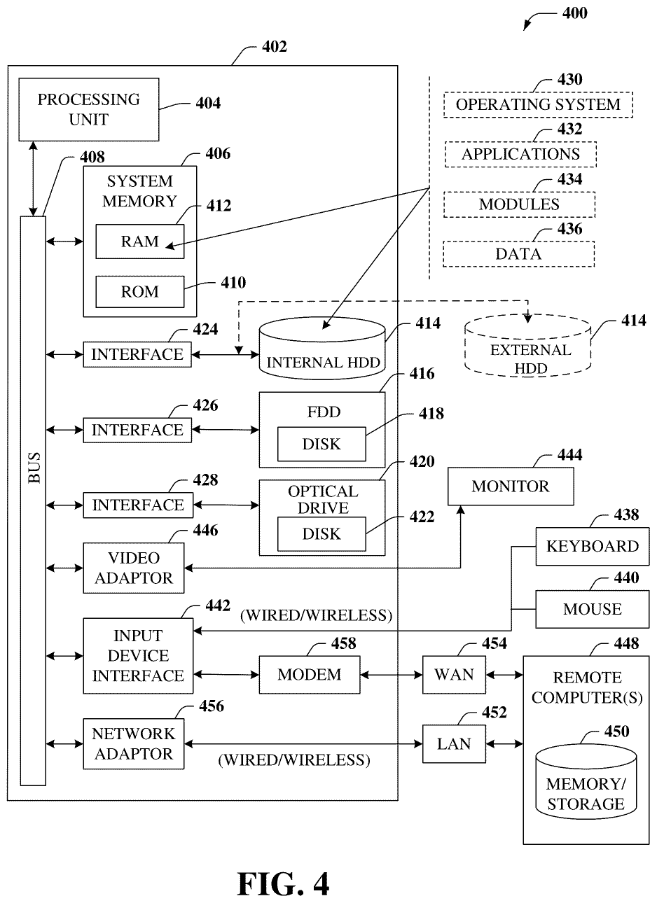

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part standardizing and managing open access lit fiber networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

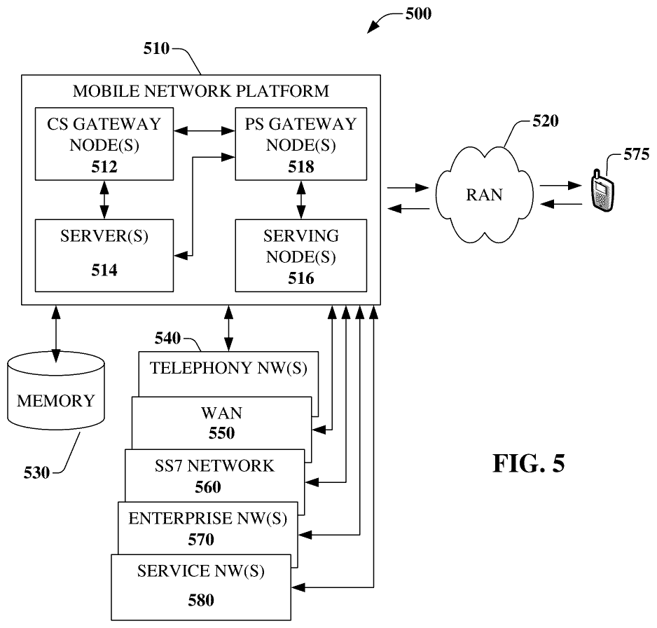

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part standardizing and managing open access lit fiber networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . .) such flows. Such application(s) can comprise add-on features to standard services (for example, provisioning, billing, customer support . . .) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

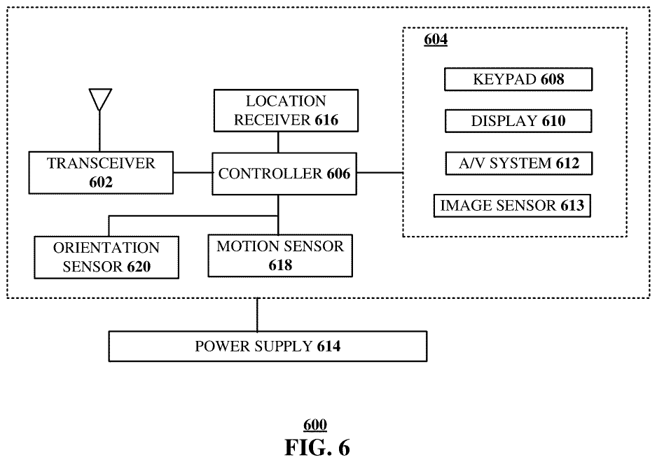

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part standardizing and managing open access lit fiber networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof.

Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device of an open access provider, comprising:
a processing system including a processor; and
a memory that stores executable instructions that, when executed by the processing system, facilitate performance of operations, the operations comprising:
sending, through an application programming interface (API) of a qualification application, a request to validate an address, wherein the qualification application supports a service provider of a fiber network;
receiving, by the API of the qualification application, a product qualification from the service provider of the fiber network to the open access provider;
receiving, through an API gateway, a product order and service activation from a customer provisioning and activation application of the service provider of the fiber network to the open access provider; and
automatically publishing, in response to completion of a milestone of the product order and service activation, a status of a product order and service activation through the API gateway to a listener of the customer provisioning and activation application.

2. The device of claim 1, the operations further comprising receiving, through an API of a dispatch application, a request for available appointments, wherein the dispatch application supports the service provider of the fiber network; and
sending, through the API of the dispatch application, a set of available appointments.

3. The device of claim 2, the operations further comprising:
receiving, through the API of the dispatch application, a reservation for an appointment of the set of available appointments; and
reserving the selected available appointment.

4. The device of claim 1, the operations further comprising storing the validated address and product qualification information in a database for future reference and auditing purposes.

5. The device of claim 1, wherein the publishing a status of a product order and service activation comprises providing, through the API gateway, a milestone notification, the milestone notification comprising completion of one or more of the address validation, the product qualification, the order generation, an appointment scheduling, a technician dispatch, and the service activation.

6-9. (canceled)

10. A non-transitory machine-readable medium, comprising executable instructions that, when executed by a processing system including a processor, facilitate performance of operations, the operations comprising:
receiving, at a first application programming interface (API) for validating customer address and for qualifying the customer addresses for service provisioning, a request from an open access provider to validate an address, wherein the first API supports a service provider of a fiber network;
providing, by the first API, a product qualification from the service provider of the fiber network to the open access provider;
providing, by a second API for ordering broadband services, a product order and service activation from the service provider of the fiber network to the open access provider; and
receiving, through a listener, a milestone notification in response to completion of a milestone of the product order and service activation.

11. The non-transitory machine-readable medium of claim 10, wherein the operations further comprise, in response to the milestone notification, updating a network inventory to reflect the product order and the service activation, wherein the milestone indicates that the product order and service activation are complete.

12. The non-transitory machine-readable medium of claim 10, wherein the operations further comprise enabling the open access provider to modify or cancel the product order through the second API.

13. The non-transitory machine-readable medium of claim 10, wherein the operations further comprise integrating the first API and the second API with a customer relationship management (CRM) system to enhance customer support and service management.

14. The non-transitory machine-readable medium of claim 10, wherein the operations further comprise providing analytics and reporting capabilities to monitor a performance and usage of the first API and the second API.

15. The non-transitory machine-readable medium of claim 10, the operations further comprising verifying an availability of network resources before providing the product qualification to the open access provider.

16. The non-transitory machine-readable medium of claim 10, the operations further comprising updating a network inventory to reflect the product order and the service activation.

17. A method, comprising:
receiving, by a processing system including a processor, at a first telecommunication forum (TMF) compatible application programming interface (API) for validating customer address and for qualifying the customer addresses for service provisioning, a request from an open access provider to validate an address, wherein the first TMF-compatible API supports an service provider of a fiber network;
verifying, by the processing system and based on a current network load and a resource availability, that a service can be delivered without causing congestion or degradation of service quality;
providing, by the processing system and in response to the verification, a product qualification from the service provider of the fiber network to the open access provider; and
providing, by a second TMF-compatible API for ordering broadband services, a product order and service activation from the service provider of the fiber network to the open access provider.

18. The method of claim 17, further comprising generating a confirmation message to the open access provider upon a successful product order and a successful service activation.

19. The method of claim 17, further comprising integrating the first TMF-compatible API and the second TMF-compatible API with an Operations Support System (OSS) to enhance network management and service delivery.

20. The method of claim 17, further comprising providing a user interface for the first TMF-compatible API and the second TMF-compatible API.

21. The non-transitory machine-readable medium of claim 10, wherein the operations further comprise integrating a qualification application accessed with the first API and a customer provisioning application accessed with the second API with an Operations Support System (OSS) to enhance network management and service delivery.

22. The non-transitory machine-readable medium of claim 10, wherein the operations further comprise providing a user interface for the open access provider to interact with a qualification application accessed with the first API and with a customer provisioning application accessed with the second API.

23. The method of claim 17, further comprising receiving, through a third TMF-compatible API, an inventory of services provided by the open access provider.

24. The method of claim 17, further comprising providing, through a fourth TMF-compatible API, an inventory of services provided by the service provider of the fiber network.
